(19) United States
(12) Patent Application Publication
(10) Pub. No.: US 2022/0311792 A1
(43) Pub. Date: Sep. 29, 2022

(54) Forensics Analysis for Malicious Insider Attack Attribution based on Activity Monitoring and Behavioral Biometrics Profiling

(71) Applicant: Plurilock Security Solutions, Victoria (CA)

(72) Inventors: Youssef Nakkabi, Victoria (CA); Paulo Quinan, Victoria (CA); Jord Tanner, Sooke (CA); Ian Paterson, Victoria (CA)

(21) Appl. No.: 17/572,730

(22) Filed: Jan. 11, 2022

Related U.S. Application Data
(60) Provisional application No. 63/166,559, filed on Mar. 26, 2021.

(51) Int. Cl. H04L 9/40; G06F 21/62

(52) U.S. Cl. CPC H04L 63/1425; H04L 63/1416; H04L 63/0861; G06F 21/6218

(57) ABSTRACT

Various implementations disclosed herein include devices, systems, and methods that facilitate the identification of perpetrators behind insider attacks. Some implementations provide a forensic analysis tool capable of performing in-depth investigations of intrusion incidents with the goal of exposing evidence that leads to attack attributions.

### RELATED APPLICATIONS

This application claims the benefit of U.S. Provisional Application Ser. No. 63/166,559 filed Mar. 26, 2021 and entitled “Forensics Analysis for Malicious Insider Attack Attribution based on Activity Monitoring and Behavioral Biometrics Profiling,” which is incorporated herein in its entirety.

### TECHNICAL FIELD

The present disclosure generally relates to malicious cybersecurity attacks and, in particular, to attributing such attacks to particular perpetrators.

### BACKGROUND

Cybersecurity attacks continue to increase in number and sophistication. A relatively common attack that takes place in many organizations is what is known as an insider attack. During an insider attack, an insider (e.g., an employee or contractor of an organization) performs a malicious activity such as removing information from the organization for personal, financial, or other form of gain or deliberately damaging the organization. Insiders may gain access to systems and information and attempt to conceal that they were the ones who accessed the systems and information by using the devices and/or credentials of other users. Various techniques attempt to prevent, stop, or mitigate insider attacks. However, existing techniques generally provide little to no explanation of the nature and the execution mode of the attacks and do not adequately assist in the identification of the perpetrators behind such attacks.

### SUMMARY

Various implementations disclosed herein include devices, systems, and methods that facilitate the identification of perpetrators behind insider attacks. Some implementations provide a forensic analysis tool configured to perform in-depth investigations of intrusion incidents with the goal of exposing evidence that leads to attack attributions. This may involve, at a processor, detecting an intrusion at an electronic device accessing non-public information or systems of an organization. An intrusion is an unauthorized access of an electronic device. The method may involve identifying biometric data associated with the electronic device during the intrusion. Such biometric data may include one or more behavioral signals. The method may involve identifying a subset of organization insiders based on the biometric data and providing a report based on the subset of organization insiders, for example, attributing the intrusion to one or more potential perpetrators.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary electronic devices operating in local and remote environments in accordance with some implementations.

FIG. 2 illustrates an example insider attack.

FIG. 3 illustrates another example insider attack.

FIG. 4 illustrates another example insider attack.

FIG. 5 is a flow chart of an exemplary method of detecting an insider attack in accordance with some implementations.

FIG. 6 is a block diagram of device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

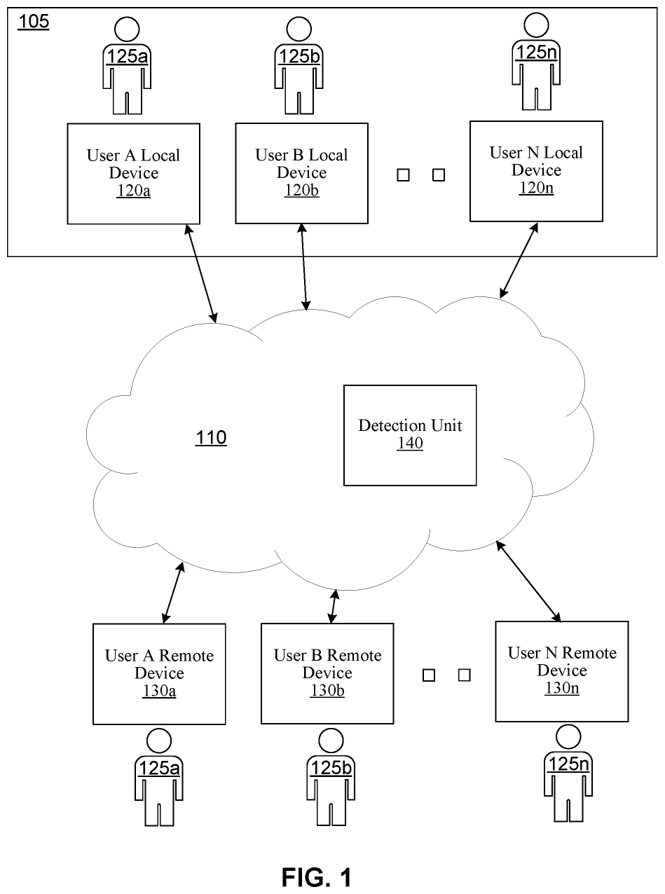

FIG. 1 illustrates exemplary electronic devices 120a-n, 130a-n operating in local and remote environments. Some of the device 120a-n are located within facility 105 and are thus are considered “local” devices in the sense that they are configured to access information systems provided/operated by the entity (e.g., business organization, government organization, partnership, etc.) that operates the facility 105. In this example, each of the devices 120a-n is assigned to a respective user 125a-n, i.e., user 125a is assigned device 120a, user 125b is assigned device 120b, etc. For example, each user may have one of the devices 120a-n at a dedicated desk, office space, cubicle, etc. within facility 105 that the respective user uses to carry out work on behalf of the entity. Accordingly, in this example, user 125a will typically work from device 120a, user 125b will typically work from device 120b, etc. To access information systems provided/operated by the entity that operates facility 105, each user may be required to satisfy a user authentication process, e.g., by providing logon credentials.

In the example of FIG. 1, the users 125a-b are also enabled to remotely access the information systems provided/operated by the entity that operates the facility 105. The users 125a-b may, as illustrated, use remote devices 130a-n, respectively, to access the information systems provided/operated by the entity through the network 110 (which may include entity operated/controlled local-area networks and/or public networks such as the Internet). To remotely access information systems provided/operated by the facility 105, each user 125a-n may be required to satisfy a user authentication process, e.g., by providing his or her logon credentials.

While requiring user authentication for access to the entity's information systems and services, various types of unauthorized access may occur. An insider attack may occur when a user of the users 125a-n accesses a device or login account that that user is not authorized to or not otherwise supposed to access.

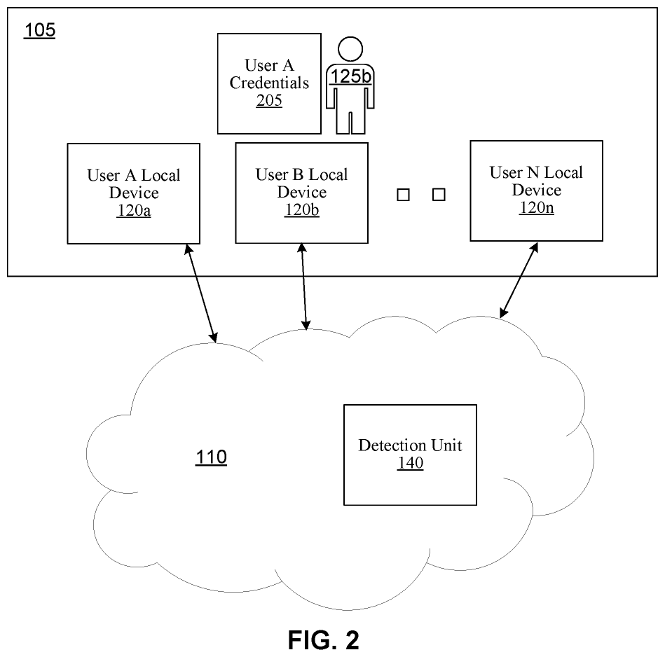

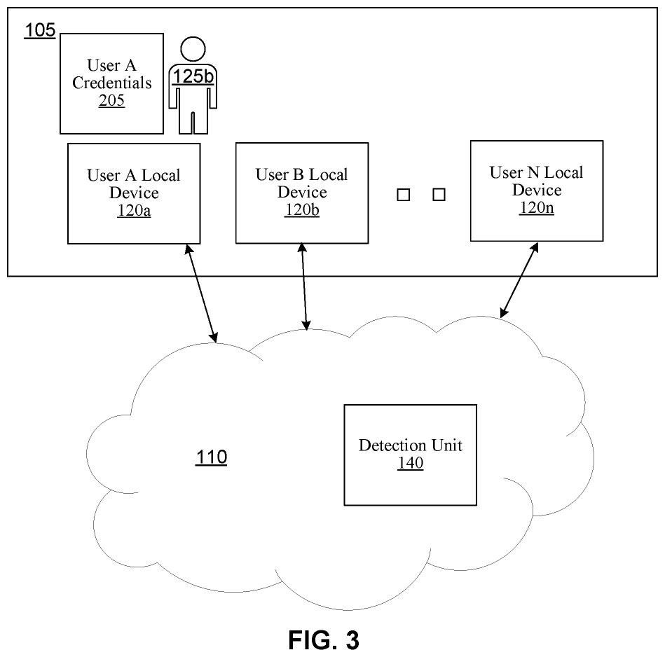

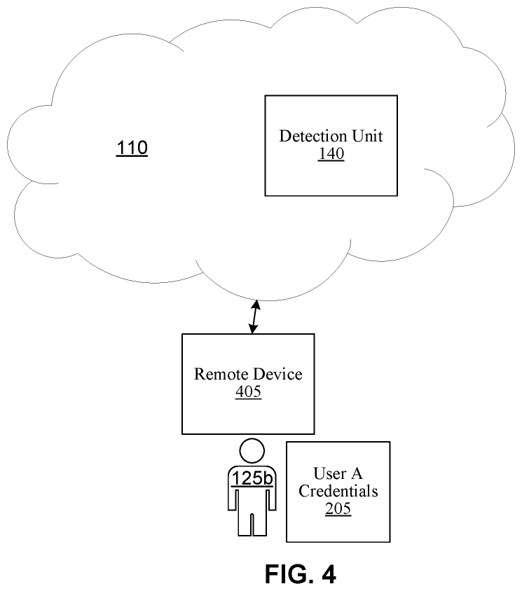

FIGS. 2-4 illustrate example insider attacks. In FIG. 2, user 125b obtains user 125A's login credentials 205 and uses those on device 120b to access the information systems. These login credentials 205 may give user 125b access to information and systems that user 125b would not otherwise be able to access, i.e., using user 125b's normal login credentials. In FIG. 3, user 125a has used his or her credentials 205 to login to device 120a and then left the device 120a unattended. User 125b than uses the device 120a (already logged in and accessible based on user 125a's credentials) to access information and systems that user 125b would not otherwise be able to access. In FIG. 4, user 125b uses a remote device 405 (which may be the user's own remote device 130a or another device) and user A credentials 205 to access the information systems that user 125b would not otherwise be able to access.

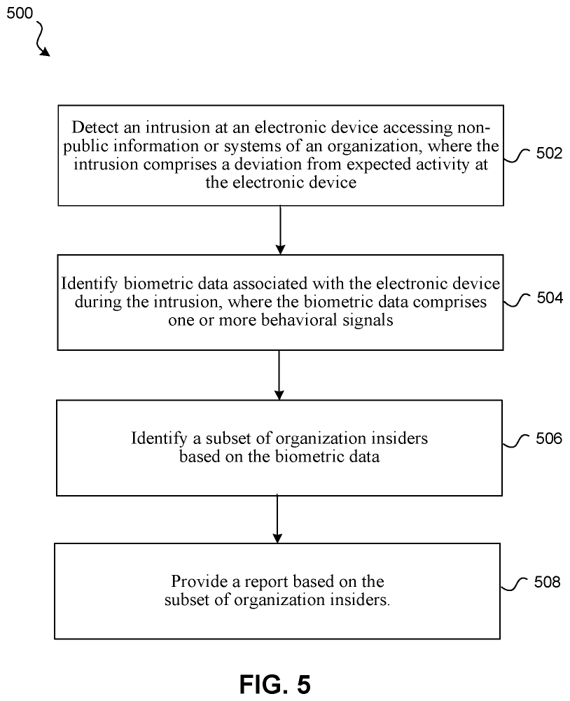

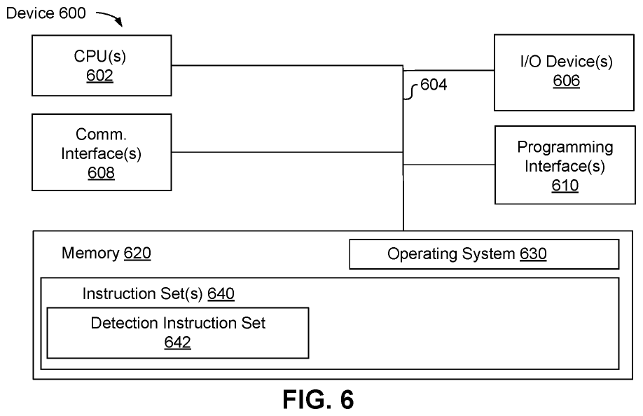

Implementations disclosed herein may identify the occurrence of and/or persons involved in an insider attack using biometric and/or other information. FIG. 5 is a flow chart of an exemplary method 500 of detecting an insider attack in accordance with some implementations. In some implementations, a device such as electronic device 600 (FIG. 6) or a combination of devices performs the steps of the method 5. In some implementations, method 500 is performed on a desktop or server device. The method 500 is performed by processing logic, including hardware, firmware, software, or a combination thereof. In some implementations, the method 500 is performed on a processor executing code stored in a non-transitory computer-readable medium (e.g., a memory).

At block 502, the method 500 detects an intrusion at an electronic device (e.g., the target's electronic device) accessing non-public information or systems of an organization, where the intrusion comprises a deviation from expected activity (e.g., behavior) at the electronic device. The intrusion may involve a malicious insider using credential of another user to gain access to one or more electronic devices to steal confidential data or perform an unauthorized action.

At block 504, the method 500 identifies biometric data associated with the electronic device during the intrusion, where the biometric data comprises one or more behavioral signals. This may involve extracting the biometric data of all profiles associated with the target user on the target's electronic device when intrusion happened.

At block 506, the method 500 identifies a subset of organization insiders based on the biometric data. This may involve comparing the biometric data against other profiles in the database and selecting top “suspects” based on relative scores of intrusion data and stored profiles. The method may execute one or more test queries for each suspect and/or calculate a score for each suspect based on predefined queries and whether the session is a remote or a local intrusion. One or more perpetrators behind an intrusion may be identified as suspects or perpetrators using behavioral biometric user identification.

Biometrics of the organization insiders may be tracked using one or more agents that monitor activities on electronic devices and systems accessed by the organization insiders. Biometric profiles may be developed using data tracked by such agents. Such data may include, but is not limited to, behavior biometric data, foreground process data, operating system events data, contextual data, application-specific data, open network connections data, or network topology data. In some implementations, biometric data associated with use of a device during the intrusion is compared with biometric data of multiple profiles. The data extraction and/or comparison may be performed within a threshold amount of time of the intrusion.

In some implementations, a subset of organization insiders is identified by selecting suspects based on scores determined using intrusion data and stored profiles. Such scores may be determined based on a behavioral characteristic exhibited by the intruder. Such scores are determined based on a characteristic recorded as having been exhibited by an insider in the past or identified as appropriate for an insider's profile.

At block 508, the method 500 provides a report based on the subset of organization insiders. (e.g., this may involve ranking suspects, determining which suspects to include in the report based on the rankings or queries, and providing details of queries in the report for further human analysis. In one example, the report identifies a single suspect as the perpetrator. In one example, the report ranks the suspects based on a score calculated or one or more queries performed for each of the suspects.

Implementations may achieve one or more of the following goals. Implementations may provide a forensics investigation capability for attack attribution by leveraging behavior biometrics, e.g., using continuous user activity monitoring and behavioral biometric profiling. Implementations may provide a user identification capability that allows searching and matching a captured intruder profile against stored profiles of insiders of the same organization. Implementations may identify attack characteristics by capturing a set of divergence characteristics of a hijacked session and feeding the set into security information management dashboards to determine the anomalous transaction source.

The techniques disclosed herein can be used in numerous circumstances including, but not limited to, the use cases illustrated in the following examples. These use cases describe incidents in which a malicious insider has previously stolen a target user's credentials (e.g., credentials of another member of the same organization) and then uses those credentials to gain access to the target electronic device, in person or remotely, to steal confidential data or perform unauthorized actions. Some implementations track biometrics of the insiders of an organization, for example, using one or more agents that monitor activities on the electronic devices and systems accessed by the organization insiders. Some implementations develop biometric profiles based on setting up electronic devices of the organization with one or more such agents to collect the following data.
a. Behavior biometric data used to build biometric profiles of the users. The data and profiles may be stored in an external database to perform periodic matching operations (e.g. authentication or continuous authentication).
b. Foreground process information
c. The operating system events log like operating system event logs, auditd and syslogd logs.
d. Contextual data such as the current connection type (remote vs local), The Active Directory user information and more
e. Application-specific data like remote user information, cached data, user application preferences, remote desktop application and more
f. List of open network connections (including protocol, local and remote addresses and ports) and associated processes
g. Network topology information

Continuous authentication results may be stored, for example, in an external database. The data associated with those results, including the biometric data and contextual data collected during each authentication period, can be stored in a separate external database or discarded once authentication is performed based on a data retention policy. The data retention policy may take into consideration data sensitivity and authentication results. Consequently, it may retain only the less sensitive data (e.g., event logs and foreground process information) and discards sensitive data (e.g., biometric data and network data). However, for anomalous results or events leading to those results, the retention level may be increased to include even sensitive data.

Some implementations identify a perpetrator behind an insider attack using behavioral biometric user identification. In one example, this involves a processor executing instructions stored on a non-transitory computer-readable medium to execute a method. The method detects an intrusion at an electronic device (e.g., the target's electronic device) accessing non-public information or systems of an organization, where the intrusion is a deviation from expected activity (e.g., behavior) at the electronic device. The method identifies biometric data associated with the electronic device during the intrusion, where the biometric data includes one or more behavioral signals. For example, this may involve extracting the biometric data of all profiles associated with the target user on the target's electronic device when the intrusion happened, e.g., within a threshold amount of time before and/or after detecting an intrusion. The method identifies a subset (e.g., one or more) of organization insiders based on the biometric data. For example, this may involve comparing biometric data against other profiles in the database and selecting top “suspects” based on relative scores of intrusion data and stored profiles. The method may execute one or more test queries for each suspect and/or calculate a score for each suspect based on predefined queries and whether the session is a remote or a local intrusion. The method may provide a report (e.g., a notification, a document, a message, etc.) based on the subset of organization insiders. This may involve ranking suspects, determining which suspects to include in the report based on the rankings or queries, and/or providing details of queries in the report for further human analysis.

One exemplary implementation involves the following steps:
1. Extract the biometric data of all profiles associated with the target user on the target's electronic device when intrusion happened;
2. Compare biometric data against other profiles in the database;
3. Select top “suspects” based on relative scores of intrusion data and stored profiles;
4. For each suspect, execute the following set of queries:
   Each example below will list the relevant queries and omit others;
   Every data is considered to be available for the sake of the example;
5. Calculate a score for each suspect based on predefined queries and whether the session is a remote or a local intrusion; and
6. Report suspects, rankings, and/or details of queries for further analysis (e.g., human review).

### Example 1: In-Person Intrusion with Local Data Exfiltration

In this exemplary use case, without being seen, a malicious insider logs into the target's electronic device to copy confidential documents. For example, this may involve the following intruder actions:
1. The intruder uses stolen credentials to gain access to the target electronic device;
2. The intruder plugs in a USB drive to where the plans to copy the confidential documents;
3. The intruder opens the file explorer and begins to navigate the file system, looking for confidential documents;
4. The intruder copies the files to the USB drive; and
5. The intruder unplugs the USB drive and logs out of the electronic device.

In this exemplary use case, the following queries may be relevant and evaluated in the above-described methods:
1. Whether the suspect's electronic device was idle or not during the time of intrusion, and if not, whether the scores during intrusion deviate from that user's historical scores;
2. Whether any device was plugged into the target electronic device during intrusion and whether the said device was ever plugged into the suspect's electronic device (info extracted from OS event logs)

### Example 2: In-Person Intrusion with the Installation of Malicious Software

In this exemplary use case, without being seen, a malicious insider logs into the target's electronic device to perform unauthorized modifications to the local electronic device, for example, by initiating a malicious software installation. For example, this may involve the following intruder actions:
1. The intruder uses stolen credentials to gain access to the target electronic device;
2. Intruder opens a network connected application (e.g., browser, SSH) to download malicious software from an external website/electronic device;
3. The intruder runs the application, so it stays in the background and sets up an auto-start script when the electronic device gets restarted; and
4. Once actions are performed intruder logs out of the electronic device.

In this exemplary use case, the following queries may be relevant and evaluated in the above-described methods:
1. Whether the suspect's electronic device was idle or not during the time of intrusion, and if not, whether the scores during intrusion deviate from that user's historical scores.
2. Identify applications executed during intrusion and whether those applications opened any new connections during the intrusion.
3. Whether any device was plugged into the target electronic device during intrusion and whether the said device was ever plugged into the suspect's electronic device (info extracted from OS event logs.

### Example 3: Remote Intrusion with Unauthorized Actions

In this exemplary use case, a malicious insider uses a remote desktop application to log into the target electronic device to perform unauthorized actions. For example, this may involve the following intruder actions:
1. The intruder uses stolen credentials to gain access to the target electronic device while using a remote desktop application.
2. The intruder opens the browser (or other application as mentioned above) to perform unauthorized actions taking advantage of locally stored credentials and device characteristics. As such, the intruder can defeat any IP or device-based protections like IP restrictions, fingerprinting or push notifications to that device. Moreover, those actions will be associated with the target's user instead of the intruder.
3. Once actions are performed intruder logs out of the electronic device

In this exemplary use case, the following queries may be relevant and evaluated in the above-described methods:
1. Whether the agents on the suspect's electronic device were running or not during the time of intrusion
2. Whether the suspect's electronic device was idle or not during the time of intrusion, and if not, whether the data collected locally during the time of intrusion matches intrusion data from a remote electronic device
3. Whether at any point during the intrusion, used any known virtual desktop application.
4. Whether the local virtual desktop application logged usage or authentication of the target's user login
5. Whether there are any reports of a connection from the suspect's IP address in the remote OS event logs during the time of intrusion
6. Whether the remote electronic device network data contains connections between from or to the suspect's IP address

Biometric user identification may be based on behavioral signals that may include data from input devices (e.g., keyboard, mouse), motion sensors (e.g., accelerometer, gyroscope and magnetometer), environmental sensors (e.g., camera, microphone, light sensor, thermometer, barometer and proximity sensor), position sensors (e.g., Global Navigation Satellite System (GNSS) such as GPS, GLONASS, etc.)), and/or physiological data sensor (e.g., heartbeat, breathing rate, ECG, wearable sensors).

Comparing biometric data and/or selecting suspects may involve determining one or more scores based on intrusion data and stored profiles. Such scores may be based on (a) a behavioral characteristic exhibited by the intruder and (b) the characteristic recorded as having been exhibited by an insider in the past or otherwise identified as appropriate for an insider's profile. As examples, the behavioral characteristic may be based on the timing of sequences of keystrokes, the timing of mouse position events, the timing of touchscreen events, and/or the timing of user hand positions during hand gesturing as captured in a sequence of images. Accordingly, the behavioral signals may correspond to timing and/or patterns. As additional examples, input data may include a time sequence of keystrokes that correspond to a particular user's typing pattern, a time sequence of mouse positions that correspond to a particular user's mouse use behavior, and/or data that corresponds to touchscreen events (x,y,z axis, pressure, duration). As another example, sensor data may correspond to a sequence of images or frames of a user's hand during hand gesture input. Some implementations interpret a stream of data (e.g., data that is received over time on an ongoing basis). In some implementations, a comparison may compare data using sliding window comparisons.

In some implementations, one or more scores are determined based on behavioral signals. Such a score may provide a measure of confidence. A score, in some implementations, is produced by using data (e.g., regarding human input, motion, peripheral device, etc.) to calculate a score. Cognitive, environmental, contextual and other signals may be used to inform the weighting of human input variables and/or the score itself.

FIG. 6 is a block diagram of device 600 in accordance with some implementations. Device 600 illustrates an exemplary device configuration. The device 600 includes one or more processing units 602 (e.g., microprocessors, ASICs, CPUs, processing cores, and/or the like), one or more input/output (I/O) devices 606, one or more communication interfaces 608 (e.g., USB, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 610, a memory 620, and one or more communication buses 604 for interconnecting these and various other components.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 include detection instruction set 642 configured to, upon execution, provide insider attack detection and/or attribution as described herein. The instruction set(s) 640 may be embodied as a single software executable or multiple software executables.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a processor,
detecting an intrusion at an electronic device accessing non-public information or systems of an organization, wherein the intrusion comprises a deviation from expected activity at the electronic device;
identifying biometric data associated with the electronic device during the intrusion, wherein the biometric data comprises one or more behavioral signals;
identifying a subset of organization insiders based on the biometric data; and
providing a report based on the subset of organization insiders.

2. The method of claim 1, wherein the intrusion comprises a malicious insider using credential of another user to gain access to one or more electronic devices to steal confidential data or perform an unauthorized action.

3. The method of claim 1, wherein biometrics of the organization insiders are tracked using one or more agents that monitor activities on electronic devices and systems accessed by the organization insiders.

4. The method of claim 3 further comprising developing biometric profiles using data tracked by agents, wherein the data comprises:
a. behavior biometric data;
b. foreground process data;
c. operating system events data;
d. contextual data;
e. application-specific data;
f. open network connections data; or
g. network topology data.

5. The method of claim 1 further comprising identifying one or more potential perpetrators behind an intrusion using behavioral biometric user identification.

6. The method of claim 1, wherein identifying the biometric data comprises extracting the biometric data of multiple profiles within a threshold amount of time of the intrusion.

7. The method of claim 1, wherein identifying the subset of organization insiders comprises selecting suspects based on scores determined using intrusion data and stored profiles.

8. The method of claim 7, wherein the scores are determined based on a behavioral characteristic exhibited by the intruder.

9. The method of claim 7, wherein the scores are determined based on a characteristic recorded as having been exhibited by an insider in the past or identified as appropriate for an insider's profile.

10. The method of claim 1, wherein identifying the subset of organization insiders comprises selecting suspects and performing one or more queries for each of the suspects.

11. The method of claim 10, wherein the intrusion is an in-person intrusion with local data exfiltration and the one or more queries comprise:
whether a suspect's electronic device was idle or not during a time of intrusion, and if not, whether scores during intrusion deviate from that user's historical scores; or
whether any device was plugged into a data port during intrusion and whether said device was ever plugged into the suspect's electronic device.

12. The method of claim 10, wherein the intrusion is an in-person intrusion with installation of malicious software and the one or more queries comprise:
whether a suspect's electronic device was idle or not during a time of intrusion, and if not, whether scores during intrusion deviate from that user's historical scores;
whether applications executed during the intrusion opened any new connections during the intrusion; or
whether any device was plugged into a data port during intrusion and whether said device was ever plugged into the suspect's electronic device.

13. The method of claim 10, wherein the intrusion is a remote intrusion with unauthorized actions and the one or more queries comprise:
whether the agents on a suspect's electronic device were running or not during the time of intrusion;
whether the suspect's electronic device was idle or not during the time of intrusion, and if not, whether the data collected locally during a time of intrusion matches intrusion data from a remote electronic device;
whether, during the intrusion, a virtual desktop application was used;
whether a local virtual desktop application logged usage or authentication of a user login; or
whether there are any reports of a connection from the suspect's IP address in the remote OS event logs during the time of intrusion; or
whether the remote electronic device network data contains connections between, from, or to the suspect's IP address.

14. The method of claim 7, wherein the report ranks the suspects based on a score calculated or one or more queries performed for each of the suspects.

15. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
detecting an intrusion at an electronic device accessing non-public information or systems of an organization, wherein the intrusion comprises a deviation from expected activity at the electronic device;
identifying biometric data associated with the electronic device during the intrusion, wherein the biometric data comprises one or more behavioral signals;
identifying a subset of organization insiders based on the biometric data; and
providing a report based on the subset of organization insiders.

16. The system of claim 15, wherein the intrusion comprises a malicious insider using credential of another user to gain access to one or more electronic devices to steal confidential data or perform an unauthorized action.

17. The system of claim 15, wherein biometrics of the organization insiders are tracked using one or more agents that monitor activities on electronic devices and systems accessed by the organization insiders.

18. The system of claim 15 further comprising identifying one or more potential perpetrators behind an intrusion using behavioral biometric user identification.

19. The system of claim 15, wherein identifying the biometric data comprises extracting the biometric data of multiple profiles within a threshold amount of time of the intrusion.

20. A non-transitory computer-readable storage medium, storing instructions executable via one or more processors to perform operations comprising:
detecting an intrusion at an electronic device accessing non-public information or systems of an organization, wherein the intrusion comprises a deviation from expected activity at the electronic device;
identifying biometric data associated with the electronic device during the intrusion, wherein the biometric data comprises one or more behavioral signals;
identifying a subset of organization insiders based on the biometric data; and
providing a report based on the subset of organization insiders.
